(19) United States
(12) Patent Application Publication
(10) Pub. No.: US 2026/0040219 A1
(43) Pub. Date: Feb. 5, 2026

(54) METHOD AND DEVICES FOR CONFIGURING UE POWER SAVING DURING DISCONTINUOUS NTN COVERAGE

(71) Applicant: Google LLC, MOUNTAIN VIEW, CA (US)

(72) Inventor: Ching-Yu LIAO, Mountain View, CA (US)

(21) Appl. No.: 18/998,767

(22) PCT Filed: Aug. 9, 2023
(86) PCT No.: PCT/US2023/029908

§ 371 Date: Jan. 27, 2025

Related U.S. Application Data
(60) Provisional application No. 63/396,593, filed on Aug. 9, 2022.

(51) Int. Cl. H04W 52/02; H04W 64/00; H04W 76/28

(52) U.S. Cl. CPC H04W 52/0235; H04W 64/00; H04W 76/28

(57) ABSTRACT

A UE and a network entity negotiate a power saving configuration for the UE shortly before the UE is temporary out-of-NTN coverage. The UE and/or the network entity detect that an out-of-NTN coverage period is upcoming based on NTN-coverage information, UE location information, and an indication as to whether the UE is to remain at a currently serving NTN. The UE transmits UE-suggested power saving parameters to the network entity, and the network entity then provides, to the UE, a power saving configuration for applying a power-saving mechanism to be applied during the out-of-NTN coverage period, in response to the UE-suggested power saving parameters.

### FIELD OF THE DISCLOSURE

This document generally describes wireless communication methods and devices communicating using non-terrestrial networks (NTNs). More particularly the described embodiments relate to configuring power saving mechanisms for a user equipment (UE) in view of an upcoming discontinuous coverage.

### BACKGROUND

This background section is provided for the purpose of generally presenting the context. Work of the presently named inventors, to the extent it is described in this background section, as well as aspects of the description that may not otherwise qualify as prior art at the time of filing, are neither expressly nor impliedly admitted as prior art.

A UE, which is a device enabling a (mobile) user's access to wireless network services, disconnects from a radio access network (RAN) when located outside RAN's coverage. The RAN provides services to UEs located within a cell associated with the RAN. Depending upon its location and subscription, the UE may connect to different networks such as a Home Public Land Mobile Network, HPLMN, (in which the user's profile is held) a Visiting PLMN, VPLMN, (when roaming), etc. Even if located within a RAN cell, a barrier to UE's connectivity may be the Radio Access Technology, RAT, if the UE and the RAN do not use same RAT.

UEs located within terrestrial cells are served by terrestrial network entities without using an NTN. The terrestrial cells are associated with fixed areas, the UEs within such cells being able to continuously connect to the RAN. NTN cells served via a satellite may be associated with different areas at different times due to evolution of satellite's location relative to the Earth surface. Therefore, a UE that is able connect to the RAN only via satellite may experience a discontinuous coverage due to a “moving” NTN cell, that is, the UE experiences periods during which it is unable to connect and communicate with the RAN via the satellite. For example, a UE may be able to connect to the RAN via satellite during an in-coverage period lasting 20 minutes every 10 hours. A mobility management entity (MME) may consider NTN coverage when sending commands and configuring UEs (e.g., for mobility management, power saving, etc.) able to connect to the RAN only via satellite (e.g., due to UE's remote location).

UEs may receive ephemeris data related to satellites from the RAN (e.g., ephemeris data may be broadcasted via a system information block such as SIB19 that includes ntn-Config information element as described in the 3GPP technical specifications) and/or other satellite assistance information. The UEs may assess satellite coverage (i.e., in coverage and out-of-coverage periods) in an area of interest where the UE is located or is going to be located using such satellite-related information. UEs may implement timers to measure out-ot-coverage periods during an application specific, AS, idle mode.

There are at least two conventionally unresolved issues related to a UE in a discontinuous coverage context. A first issue is a mobility management aspect: a UE without service from an NTN RAN (i.e., in a discontinuous coverage area during an out-of-coverage period) has to decide whether to wait for an in-coverage period or to seek a different RAN. A second issue is timely configuring a power saving mechanism to be used by the UE during the an out-of-coverage period.

### SUMMARY

UE and network entity (NE) devices according to various embodiments negotiate a power saving configuration for the UE shortly before the UE is temporarily out-of-non-terrestrial-network, NTN, coverage. Upon detecting an upcoming out-of-NTN coverage period (during which the UE is unable to communicate via the NTN), the UE transmits suggested power saving parameters to an NE. In view of the UE-suggested power saving parameters, the NE provides, to the UE, a power saving configuration for applying a power-saving mechanism during the out-of-NTN coverage period. The NE may be a base station or a device performing an Access and Mobility Management Function, AMF, as defined in 3GPP technical specifications.

The UE and the NE may independently assess the out-of-NTN coverage period. Alternatively or additionally, the UE or the NE detects an upcoming out-of-NTN coverage period and indicates it to the other. The power-saving mechanism may be one of Power Saving Mode (PSM), Mobile Initiated Connection Only (MICO), and/or extended Discontinuous Reception (eDRX) as currently defined in 3GPP technical specifications. Performing the negotiation may be conditioned on the UE being configured to refrain from seeking other radio communication access during the out-of-NTN coverage period. The UE may be configured to refrain from seeking other radio communication access, during a registration period or later via Steering of Roaming (SoR) information. The NE may configure the UE to refrain from seeking other radio communication access based on a StayIndication associated with the NTN's radio access network identifier optionally retrieved from a repository of network-related information (e.g., an HPLMN).

### BRIEF DESCRIPTION OF THE DRAWINGS

The accompanying drawings, which are incorporated in and constitute a part of the specification, illustrate one or more embodiments and, together with the description, explain the embodiments.

FIG. 1 is a block diagram of a wireless communication system including a user equipment, UE, and network entities, NEs, for configuring UE power saving during discontinuous NTN coverage, according to an embodiment.

FIG. 2 is a schematic representation of communication via a satellite of the UE and NEs in FIG. 1.

FIG. 3 is a diagram illustrating discontinuous NTN coverage for the UE in FIG. 1.

FIG. 4 is a signal diagram corresponding to a preparation stage during initial UE registration that configures a UE to refrain from seeking other radio communication during discontinuous NTN coverage, according to an embodiment.

FIG. 5 is a signal diagram corresponding to a preparation stage after initial UE registration that configures a UE to refrain from seeking other radio communication during discontinuous NTN coverage, according to an embodiment.

FIG. 6 is a signal diagram corresponding to a preparation stage during initial UE registration with a VPLMN that configures a UE to refrain from seeking other radio communication during discontinuous NTN coverage, according to an embodiment.

FIG. 7 is a signal diagram corresponding to a preparation stage after initial UE registration with a HPLMN that configures a UE to refrain from seeking other radio communication during discontinuous NTN coverage, according to an embodiment.

FIG. 8 is a signal diagram corresponding to an execution stage prior to an NTN coverage discontinuity where the UE triggers a UE power saving configuration, according to an embodiment.

FIG. 9 is a signal diagram corresponding to an execution stage prior to an NTN coverage discontinuity where the AMF triggers a UE power saving configuration, according to an embodiment.

FIG. 10 is a signal diagram corresponding to an execution stage prior to an NTN coverage discontinuity where the NG-RAN triggers a UE power saving configuration, according to an embodiment.

FIG. 11 is a flowchart of a UE method, according to an embodiment.

FIG. 12 is a flowchart of a UE method for negotiating power saving parameters for an upcoming out-of-NTN coverage, according to another embodiment.

FIG. 13 is a flowchart of a NE method for negotiating power saving parameters for an upcoming out-of-NTN coverage, according to an embodiment.

FIG. 14 is a structural representation of a UE and an NE configured for managing a power saving configuration for an upcoming discontinuous NTN coverage, according to various embodiments.

### DETAILED DESCRIPTION

A user equipment, UE, and a network entity, NE, described in this section perform various techniques for power saving and mobility management associated with discontinuous non-terrestrial network, NTN, coverage.

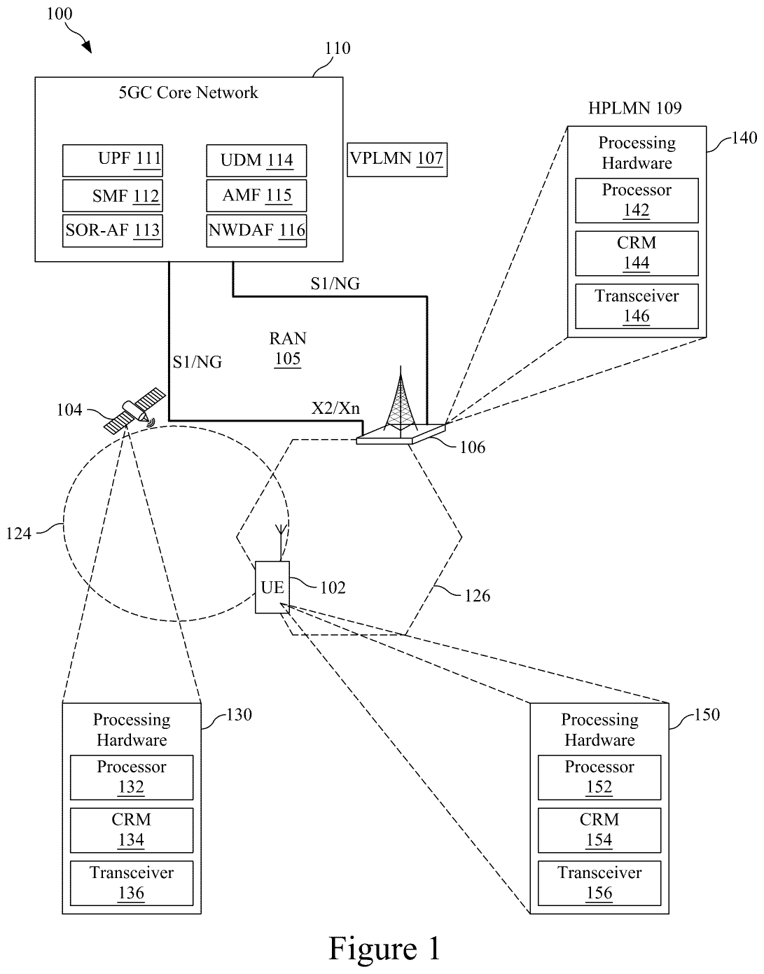

Referring first to FIG. 1, a wireless communication system 100 includes a UE 102, an NTN base station (BS) 104, a terrestrial network (TN) base station 106, and a core network (CN) 110 configured to timely negotiate UE power saving during discontinuous NTN coverage. The NTN base station 104 communicates with UE 102 via satellite. The base stations 104 and 106 operate in a Radio Access Network (RAN) 105 connected to the CN 110. In FIG. 1, the CN 110 includes 5G core functions thus being a 5G core (5GC) but it may also be implemented as a sixth generation core, 6GC, or an LTE core.

The NTN base station 104 serves UEs within a cell 124, and the base station 106 serves UEs within a cell 126. If the base station 104 and/or 106 is a gNB, the cell 124 and/or 126, respectively, is a New Radio, NR, cell. If the base station 104 and/or 106 is an ng-eNB or eNB, the cell 124 and/or 126 is an evolved universal terrestrial radio access, E-UTRA, cell. The cells 124 and 126 may be in the same Radio Access Network Notification Area, RNA, or different RNAs. In general, the RAN 105 includes any number of base stations, and each of the base stations covers (i.e., serve UEs within) one, two, three, or any other suitable number of cells. The UE 102 supports at least one of a 5G NR (or simply, “NR”) or E-UTRA air interface to communicate with one or both base stations 104 and 106. Each of the base stations 104, 106 connects to the 5GC 110 via an interface (e.g., S1 or NG interface). The base stations may also be interconnected via an interface (e.g., an X2 or an Xn interface for interconnecting NG RAN nodes).

The 5G CN 110 may be hosted by one or more physical devices that may be collocated. In this document, base stations and physical devices hosting core network functions/modules may be called network entities (NEs) generally. Among other components, 5GC 110 includes an Access and Mobility Management Function (AMF) 115, and/or a Session Management Function (SMF) 112. Generally speaking, the UPF 111 is configured to transfer user-plane packets related to audio calls, video calls, Internet traffic, etc., the AMF 115 is configured to manage authentication, registration, paging, and other related functions, and the SMF 112 is configured to manage Packet Data Unit, PDU, sessions.

As illustrated in FIG. 1, the base station 104 supports (i.e., covers, serves UEs within) the cell 124, and the base station 106 supports a cell 126. The cells 124 and 126 may partially overlap, so that the UE 102 selects, reselects, or is handed over from one of the cells 124 and 126 to the other. To directly exchange messages or information, the base station 104 and the base station 106 support an X2 or Xn interface. In general, the 5GC core network 110 connects to any suitable number of base stations supporting NR cells and/or EUTRA cells, using, for example, an S1 or an NG interface.

As discussed in detail below, the UE 102 and/or NEs of the 5G system (5GS) may utilize the techniques described in this section for negotiating power management techniques and parameter for when the radio connection between the UE 102 and the RAN 105 is suspended, e.g., when there is no satellite access. The term “network entity” stands for a device with a well-defined cellular network functionality (e.g., connecting UEs to the core network including managing communications to and from the UEs).

The base station 104 is equipped with processing hardware 130 that includes one or more general-purpose processors (e.g., CPUs) 132 and a non-transitory computer-readable memory 134 storing instructions that the one or more general-purpose processors execute. Additionally or alternatively, the processing hardware 130 may include special-purpose processing units. The processor 132 is configured to process data that the base station 104 receives in the uplink direction or transmits in the downlink direction according to various techniques described in this section. The processing hardware 130 also includes a transceiver 136 (term that here stands also for antenna(s) and radio-frequency front-end electronics that are not illustrated separately in this figure) configured to transmit the data in the downlink direction and to receive data in the uplink direction. The base station 106 includes generally similar components. In particular, components 140, 142, 144, and 146 of the base station 106 are similar to the components 130, 132, 134, and 136, respectively. The base station 106 may run an instance of HPLMN 109.

The UE 102 is equipped with processing hardware 150 that includes one or more general-purpose processors 152 such as CPUs and non-transitory computer-readable memory 154 storing machine-readable instructions executable on the one or more general-purpose processors, and/or special-purpose processing units. The processor 152 is configured to process data that the UE 102 transmits in the uplink direction and/or receives in the downlink direction. The processing hardware 150 may also include a transceiver 156 (term that here stands also for antenna(s) and radio-frequency front-end electronics that are not illustrated separately in this figure) configured to transmit and receive data.

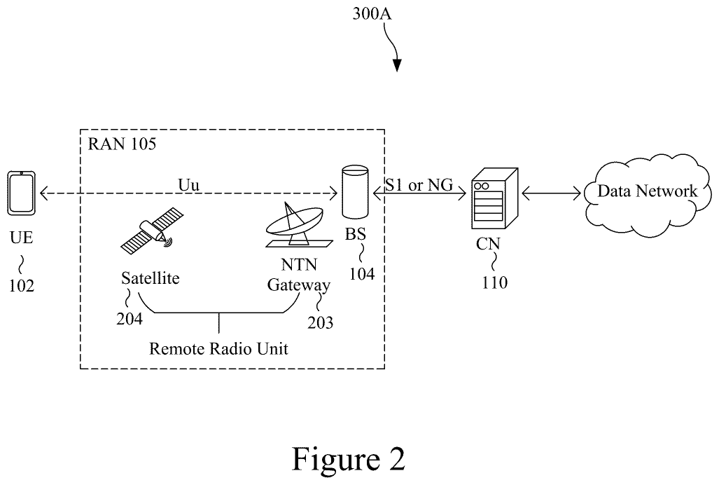

FIG. 2 illustrates a certain type of NTN deployment referred to as transparent payload architecture, which involves a satellite gateway (also known as an NTN Gateway) 203 and a “transparent” satellite 204 for extending the range of the Uu interface. The satellite 204 implements a frequency conversion and a Radio Frequency (RF) amplifier in both the uplink and downlink directions. The satellite function is similar to that of an analog RF repeater. As a result, the satellite 204 repeats the Uu radio interface from the feeder link (between the NTN gateway and the satellite) to the service link (between the satellite and the UE) in the downlink direction and vice versa in the uplink direction. The Satellite Radio Interface, SRI, on the feeder link is the Uu, and the NTN gateway 203 supports all necessary functions to forward the signal of the Uu interface. The NTN gateway 203 may be placed at the same location as the base station (e.g., eNB or gNB) 104, or may be connected to the base station 104 via a wired link. It is also possible to connect more than one NTN gateway to a base station. Different transparent satellites may be connected to the same base station on the ground, via the same NTN gateway, or via different NTN gateways.

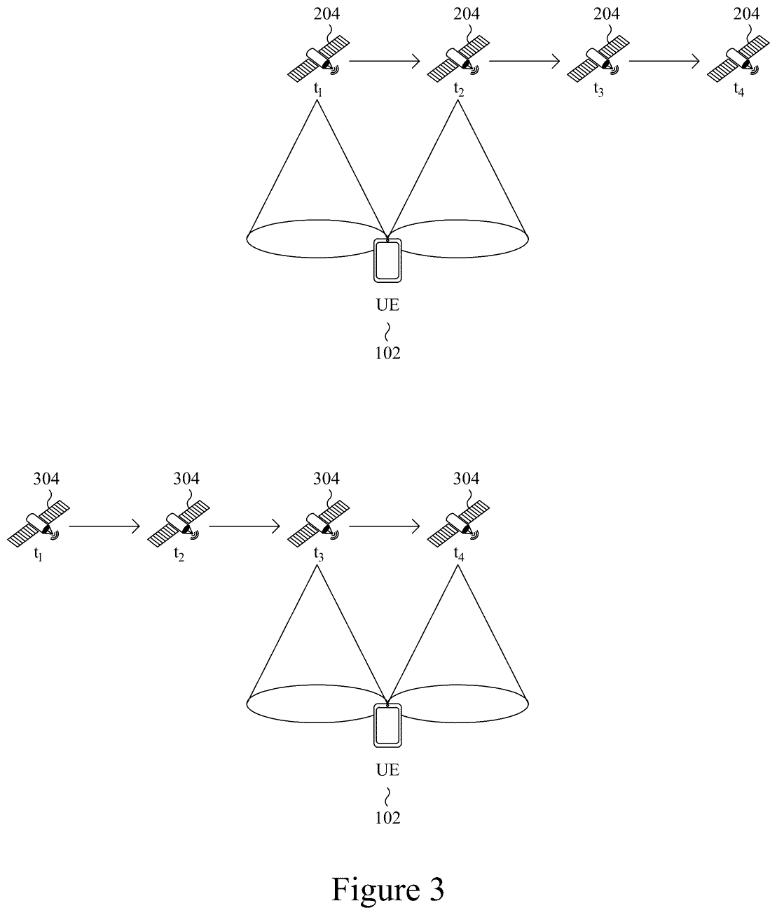

FIG. 3 is a diagram illustrating discontinuous NTN coverage for a UE. For ease of explanation, assume the UE 102 is stationary and located in the concerned geographical area that experiences discontinuous coverage. As illustrated in the upper part of FIG. 3, the UE 102 is in a cell served by a low earth orbit, LEO, satellite 204 from t1 to t2, and then, as illustrated in the lower part of FIG. 3, the UE 102 served by another LEO satellite 304 from t3 to t4. In the period between t2 to t3, the UE 102 is not served by any satellite or any terrestrial base station and therefore is disconnected from the RAN. When losing its connection a serving cell, the UE may start seeking other cells to connect. However, in the example illustrated in FIG. 3, the UE 102 cannot find a cell between t2 to t3 which may last minutes or hours. The cell search causes extra, unnecessary power consumption in the UE 102.

To reduce power consumption at the UE in particular NTN scenarios such as the one depicted in FIG. 3, the UE 102, for example, may not be required to perform the cell search and may deactivate the Access Stratum, AS, functions during the period when the UE is not within the area of coverage of a satellite. In some implementations, the UE has knowledge of when the UE will be outside the area of coverage, and when the UE will be within an area of coverage again, in order to activate its cell search or AS functions again before the UE falls into the coverage of another NTN cell. For example, the ephemeris information broadcasted in the system information provides the constellation and trajectory/movement information of the serving and the neighboring satellites, which helps UE to predict/estimate when it will be within and when it will be outside the NTN coverage. The InformationElement, IE, EphemerisInfo provides satellite ephemeris information. Ephemeris information may be expressed either in a format of position and velocity state vector or in a format of orbital parameters.

In addition to the ephemeris information, the UE may use other information to estimate/predict coverage of an NTN cell more precisely. Embodiments associated with UE power saving mechanisms are described in more detail below.

In terms of the satellite moving pattern, there are three types of service links that are supported in NTN: (1) Earth-fixed for satellites that provide beam(s) continuously covering the same geographical areas (e.g., GEO/GSO satellites); (2) Quasi-Earth-fixed for satellites that provide beam(s) covering one geographic area for a limited period and a different geographic area during another period (e.g., low earth orbit/medium earth orbit, LEO/MEO, satellites capable of using steerable beams); and (3) Earth-moving for satellites that provide beam(s) whose coverage area slides over the Earth surface (e.g., LEO/MEO satellites using fixed or non-steerable beams).

Thus, an eNB connected via NTN may provide either quasi-Earth-fixed cell coverage or Earth-moving cell coverage using LEO/MEO satellites. The eNB provides Earth fixed cell coverage using GEO satellites.

Considering different use cases of UE/Next Generation-Radio Access Network, NG-RAN/5G core network, CN, awareness of NTN coverage and UE location, the UEs (with or without network assistant information) and NEs of various embodiments are enabled (1) to determine whether to remain with the current NTN, or to attempt to register on available cells of different networks (e.g., Public Land Mobile Networks, PLMNs) to receive the normal service during discontinuous NTN coverage in current NTN, and/or (2) to use of the NTN coverage/UE location information to timely negotiate parameters of power saving mechanisms (e.g., PSM, MICO mode, and eDRX for UE in CM-IDLE state) to be used by the UEs while out-of-NTN coverage.

The UE tends to know its location more so than the network (i.e., network entities and functions) serving the UE. The UE and NE may calculate travel paths of satellites and their associated coverage areas (and related time windows) based on Ephemeris data. Embodiments described herein use out-of-NTN coverage estimates to timely negotiate power saving parameters and exchange mobility management information before the UE leaves NTN coverage. Examples of power saving management mechanisms used herein include, but are not limited to, power saving mechanism (PSM), mobile initiated connection only (MICO), and extended discontinuous reception (eDRX) as described, for example in 3GPP technical specifications.

PSM, which is frequently used for Internet-of-Things (IoT) UEs, enables UEs to enter a deep-sleep mode for long periods of time after notifying the base station. PSM parameters include a timer setting (e.g., an extended timer, during which time a connected application/object or the UE itself is unable to receive any data, messages and the like from a network which in turn may extend battery life). When in MICO mode, the UE is similarly considered to be unreachable and may not receive any Access Stratum message thereby reducing power usage. MICO parameters also include a timer. eDRX allows the UE to operate in a listening only mode for pending transmissions without operating in a fully awake/connected mode which also reduces power consumption of the UE. A parameter of eDRX is idle-mode cycle length.

The NTN is a non-geostationary, GEO, satellite network in this embodiment. As the satellites move relative to the Earth, their antenna beams cover different areas on the Earth surface. A satellite RAT is described herein as an example for a UE accessing a PLMN/satellite RAT. Embodiments now described may be implemented in a UE with a single-RAT-only capability or a UE configured with information for staying at a current PLMN/RAT by the operators based on operator policies, UE subscriptions, etc. The embodiments described herein are applicable for network operators of PLMNs and other Non-Public Networks.

For UE/5G CN/NG-RAN awareness of NTN coverage, the UE/5G CN/NG-RAN is assumed to be able to calculate the estimate of the out-of-NTN coverage period and estimate of the in-NTN coverage period based on the information of NTN coverage, e.g., ephemeris data of Satellites, and UE location. For UE awareness of NTN coverage, it is assumed that the UE acquires satellite-related information, for example, from a broadcasted system information block (e.g., SIB 19) or receives more rigorous NTN coverage information from the 5G CN or application function, AF. For NG-RAN awareness of NTN coverage, it is assumed that the NG-RAN node may get rigorous NTN coverage information, e.g., including other cells in other NG-RAN nodes from O&M or 5G CN, e.g., Access and Mobility Management Function/Network Data Analytics Function, AMF/NWDAF. For AMF awareness of NTN coverage, it is assumed that the AMF may get rigorous NTN coverage information from other NFs in 5G CN (e.g., NWDAF), or NG-RAN.

For UE location information, it is assumed that the UE has the capability to determine its location (e.g. by global navigation satellite system, GNSS, or by positioning procedures at the UE as indicated in 3GPP technical documents) and has user consent to provide its location to the NG-RAN/5G CN/AF in the solutions. For NG-RAN awareness of UE location, it is assumed the NG-RAN may get the estimate of UE location information from 5G CN or from the UE. For AMF awareness of UE location, it is assumed the AMF may acquire the estimate of UE location information from other NFs in 5G CN, from the UE or from the NG-RAN node.

In some embodiments, the UE's power saving management function may be implemented not only as software but also as hardware logic and/or circuitry.

In an embodiment, an NE performing, for example, as part of an HPLMN provides information enabling a UE to determine whether to stay with its current PLMN/satellite RAT while out-of-NTN coverage. Inputs for this determination may include one or more of (1) the UE's capabilities with respect to the satellite RAT, (2) UE subscriptions stored at the network (e.g., the HPLMN Unified Data Management, UDM) and (3) service level agreements, SLAs, with other mobile network operators (MNOs).

In some embodiments, the provided information is called StayIndication and indicates whether the UE is to stay or not stay at the serving PLMN/Satellite RAT if the UE is out of NTN coverage. StayIndication may be provided using a stand-alone message, incorporated into currently existing message(s), and/or as one or more fields across one or more messages. The embodiments are not limited to “StayIndication”. Other fields with other names and/or other messages with other fields may include similar information enabling the UE to determine whether or not to stay at the serving PLMN/Satellite RAT if the UE is out of NTN coverage (i.e., StayIndication is a non-limiting example). The information may be an indication associated with a radio access network, RAN, identifier of the NTN.

In an implementation, the HPLMN UDM configures one or more messages to send a StayIndication to the UE. There may be one or more methods for indicating/implementing different granularities of StayIndication related to the PLMN for the UE.

In an embodiment, the StayIndication is configured and applied for any PLMN in an Equivalent PLMN, EHPLMN, list, i.e., if the StayIndication is provided to a UE, it is applied to any PLMN in the EHPLMN. For example, when the UE receives the NAS message including the StayIndication, the UE applies the StayIndication settings for all of the PLMNs included in the EHPLMN list when using the Satellite RAT.

In another embodiment, StayIndication is configured and applied per PLMN in an EHPLMN list, i.e., the StayIndication and PLMN pair is provided to configure Stay Indication per PLMN in the EHPLMN. For example, if the UE receives the Network Access Stratum, NAS, message including a StayIndication with a list of PLMNs (based on the EHPLMN list), and when the UE accesses a PLMN/Satellite RAT and the PLMN is in the StayIndication PLMN list, the UE stays at the PLMN/Satellite RAT while entering idle mode and out of NTN coverage. The StayIndication PLMN list may be updated in the registration request with registration type of Mobility update.

In yet another embodiment, a StayIndication is configured only for the PLMN that the UE is currently registered with, i.e., if the StayIndication is provided, it is applied to the registered PLMN which may or may not be in the EHPLMN list. For example, when the UE receives the NAS message including a StayIndication, the UE applies the StayIndication only for the current PLMN when using Satellite RAT. When the UE registers to a new PLMN, the UE deletes the StayIndication. If the UE receives a new StayIndication from the same registered PLMN, the UE applies the latest Stay Indication.

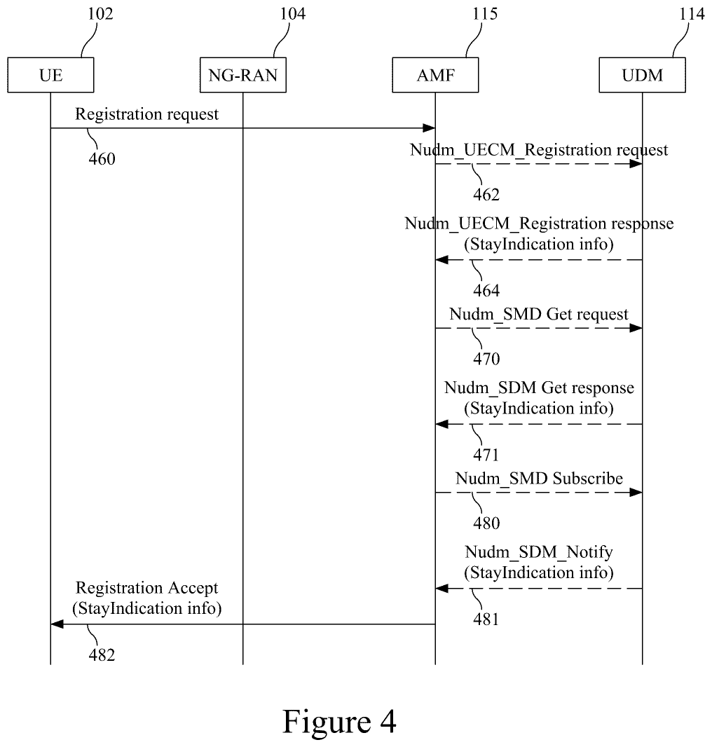

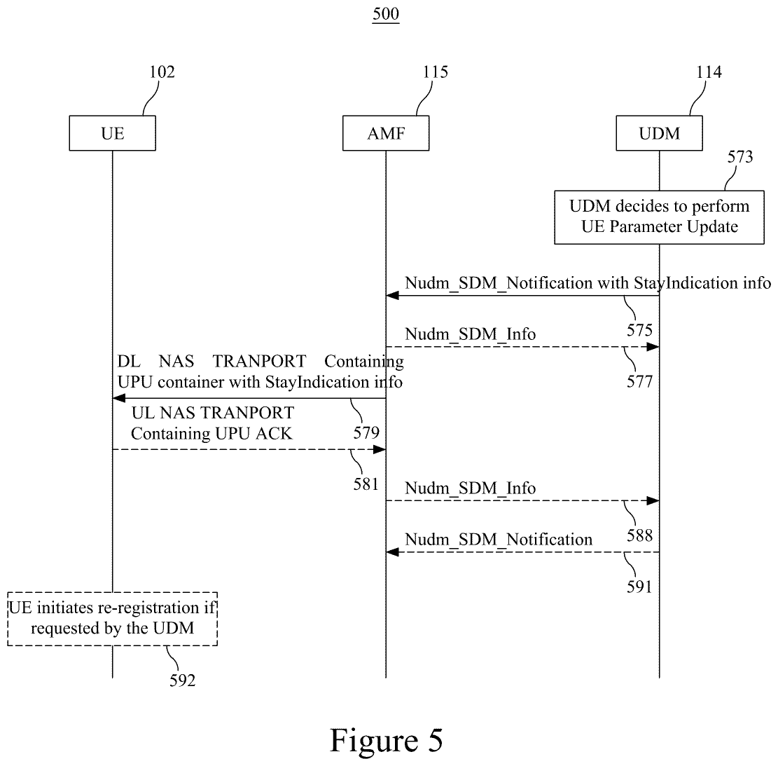

StayIndication may be transmitted to the UE using various techniques as described below with respect to FIGS. 4 and 5. FIG. 4 is a signal diagram corresponding to a preparation stage configuring a UE to refrain from seeking other radio communication during discontinuous NTN coverage during initial UE registration, according to an embodiment. According to this approach, the UE 102 receives a Network Access Stratum, NAS, message including the configuration from HPLMN, which may be Registration Accept message in Registration procedure performed by a UE 102, a NG-RAN 104, an AMF 115 and a Unified Data Management, UDM, 114. Initially, the UE 102 transmits a Registration Request message 460 to the AMF 115 via the NG-RAN 104. The Registration Request message 460 may be part of a negotiation process by the UE 102 with the network related to power saving mechanisms and parameters.

In an embodiment, during the registration process, after receiving the Registration Request message 460 from the UE 102, the HPLMN (not illustrated in this figure) may begin a process for configuring Stay Indication for the UE. The AMF 115 then transmits a Nudm_UECM_Registration request message 462 to the UDM 114 and then receives, from the UDM 114, a Nudm_UECM_Registration response message 464, which may include Stay Indication information. The AMF 115 and the UDM 114 may also exchange an Nudm_SDM Get request message 470 and an Nudm_SDM Get response message 471, which may also include StayIndication information. The information exchange between the AMF 115 and the UDM 114 may be completed for this registration process 400 with the AMF 115 sending an Nudm_SDM Subscribe message 480 to the UDM 114, and the UDM 114 replying with an Nudm_SDM_Notify message 481, which may include Stay Indication information (with SDM being associated with Subscriber Data Management). The process may include subscribing to a new notification event if there is a change in StayIndication. The AMF 115 finally transmits a Registration Accept message 482 to the UE 102 with the StayIndication information for the UE to use as described herein.

In another embodiment, a downlink, DL, NAS Transport message in a UE parameter(s) update procedure may be used to transmit the Stay Indication information. FIG. 5 is a signal diagram corresponding to a preparation stage configuring a UE to refrain from seeking other radio communication during discontinuous NTN coverage after initial UE registration, according to an embodiment. This signal diagram is similar with the one illustrated in 3GPP TS 23.502 FIG. 4.20.2-1 and modified to include the StayIndication in the existing step 2 Nudm_SDM_Notification and passed it down in step 4 within the DL NAS TRANSPORT message.

Instead of responding to a request per FIG. 4, the UDM 114 may decide to perform a UE parameter update which may include the Stay Indication information to “push” the StayIndication to the UE 102. The HPLMN (not shown) may update such UE parameters based on the operator policies. Further, the procedure illustrated in FIG. 5 allows the network to provide a specific set of parameters including Stay Indication to the UE 102 (parameters generated and stored in the UDM 114) by delivering protected UDM update data via NAS signaling. The update may be triggered, for example, by network operator policies.

FIG. 5 shows a signaling diagram 500 illustrating a UE parameter update, via UDM control plane procedure. In FIG. 5, the UE 102 communicates with the AMF 115 which in turn communicates with the UDM 114.

Upon deciding 573 to perform a UE parameter update, the UDM 114 transmits an Nudm SDM_Notification message 575 that includes StayIndication information to the AMF 114. The AMF 115 optionally responds with an Nudm_SDM_Info message 577. The AMF 115 then transmits a DL NAS Transport message 579 that contains a UE parameter update, UPU, container and includes the StayIndication information to the UE 102. Further, the UE 102 optionally transmits a UL NAS Transport message 581 that contains a UPU acknowledgment to the AMF 115. The AMF 115 optionally transmits an Nudm_SDM_Info message 588 to the UDM 114, which responds with an Nudm_SDM_Notification message 591. When the DL NAS Transport message 579 includes a request from the UDM 114 to perform a re-registration, the UE 102 initiates a re-registration procedure 592.

When the UE is registering to a Visited PLMN (VPLMN) 107 (e.g., registering in other countries), the HPLMN UDM triggers a Steering of Roaming, SoR, retrieval procedure during and after the registration procedure, as generally described in 3GPP technical specifications. SoR directs a roaming subscriber to a so-called preferred network and/or a network based steering function to allow distribution of roaming subscribers in visited networks.

In an embodiment, the Stay Indication is configured and applied on a per-PLMN basis if the PLMN is combined with a satellite RAT in a combined PLMN/RAT list in priority order, i.e., the StayIndication is added in the combined PLMN/RAT list for each PLMN with a satellite RAT.

An example of the list of the combined PLMN/RAT in a priority order may be as follows: (1) PLMN #1, 5G-NR; (2) PLMN #1, satellite RAT, Stayindication=active (stay); (3) PLMN #2, satellite RAT, Stayindication =inactive (not stay); (4) PLMN #3, 5G-NR; (5) PLMN #2, 5G-NR; and (6) other combinations as desired.

When the UE accesses a PLMN #1/satellite RAT with a StayIndication indicated as active, the UE stays at the PLMN #1/Satellite RAT while entering idle mode and out-of-NTN coverage.

During the UE's registering to the VPLMN/Satellite RAT, two embodiments are described to configure information of StayIndication via the PLMN/RAT list in SoR information to the UE based at least in part on 3GPP technical specifications (e.g., a 3GPP procedure for providing list of preferred PLMN/access technology combinations, as described below for some embodiments).

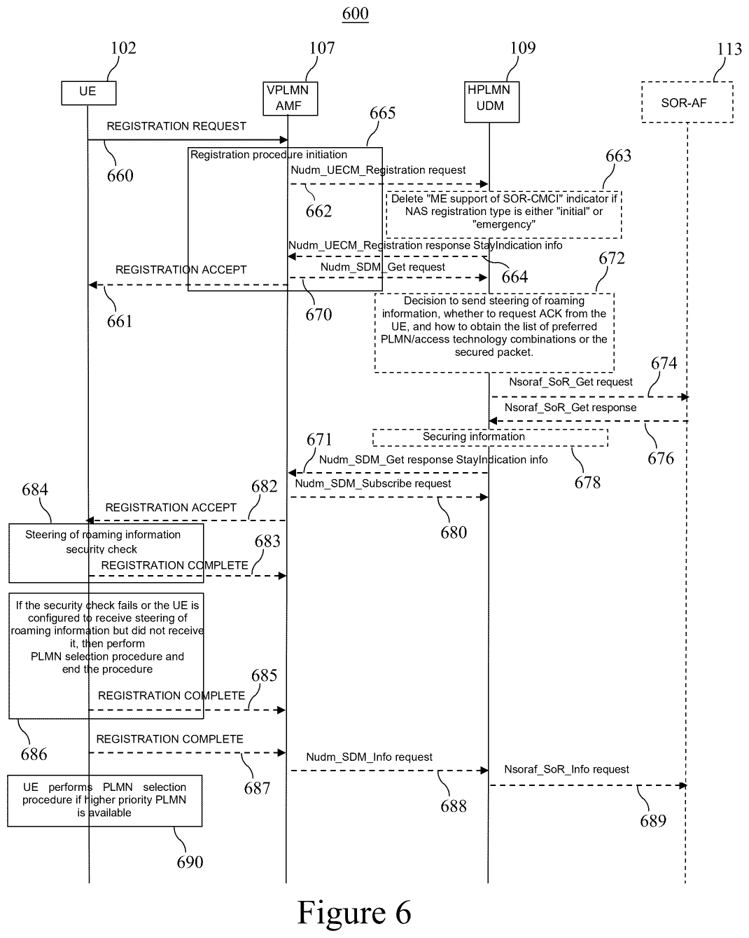

Prior to describing the two options associated with StayIndication and SoR, a general registration process 600 associated with SoR is described with respect to FIG. 6. Various steps/messages of FIG. 6 are modified according to the two options to provide Stay Indication information to the UE 102 in the context of SoR.

FIG. 6 is a signal diagram corresponding to a preparation stage configuring a UE to refrain from seeking other radio communication during discontinuous NTN coverage. This preparation stage occurs during initial UE registration with a VPLMN, according to an embodiment. The UE 102 transmits a Registration Request 660 to the VPLMN AMF 107. A registration procedure initiation 665 includes: (1) the VPLMN AMF 107 transmitting an Nudm_UECM_Registration request message 662 to the HPLMN UDM 109; (2) the HPLMN UDM 109 that deletes 663 an ME support of SOR-CMCI indicator if NAS registration type is either “initial” or “emergency” then transmits a Nudm_UECM_Registration response message 664 to the VPLMN AMF 107; (3) the VPLMN AMF 107 then transmits A Registration Accept message 661 to the UE 102 and an Nudm_SDM_Get request message 670 to the HPLMN UDM 109. HPLMN UDM 109 decides 672 whether to send SoR information and whether to request an acknowledgement, ACK, from the UE 102 and how to obtain a list of preferred PLMN/access technology combinations or the secured packet. Based on this decision, the HPLMN UDM 109 may transmit a Nsoraf_SoR_Get request message 674 to the SoR application function, AF, 113, which then responds with an Nsoraf_SoR_Get response message 676 to the HPLMN UDM 109. The HPLMN UDM 109 may then perform a securing information event 678. The HPLMN UDM 109 may further transmit an Nudm_SDM_Get response message 671 to the VPLMN AMF 107 that may later transmit an Nudm_SDM_Subscribe request message 680.

The VPLMN AMF 107 optionally transmits a Registration Accept message 682 to the UE 102. The UE 102 than performs 684 a Steering of Roaming information security check. If the security check passes, then the UE 102 sends a Registration Complete message 683 to VPLMN AMF 107. If the security check fails or the UE 102 is configured to receive Steering of Roaming information but did not receive it, the UE 102 performs a PLMN selection procedure 686 and ends this procedure by transmitting a Registration Complete message 685. Upon completion of either event 684 or event 686 a Registration Complete message 687 (which may represent either message 683 or 685) is transmitted to the VPLMN AMF 107. The VPLMN AMF 107 then transmits an Nudm_SDM_info request message 688 to the HPLMN UDM 109 which transmits an Nsoraf_SoR_Info request message 689 to the SoR-AF 113. Also, the UE 102 may perform a PLMN selection procedure 690 if a higher priority PLMN is available.

According to an embodiment, when receiving SoR information from the SOR-AF 113, the HPLMN UDM 109 includes StayIndication information per PLMN with Satellite RAT in the combined PLMN/RAT list. This embodiment uses the signals (modified) as shown in FIG. 6. The Nudm_SDM_Get response message 671 may include SoR info with Stay Indication information. This StayIndication per PLMN with satellite RAT in the combined PLMN/RAT list may then be included in the Registration Accept message 682 transmitted from the VPLMN AMF 107 to the UE 102.

According to another embodiment, the SoR-AF 113 includes Stay Indication information per PLMN with Satellite RAT in the combined PLMN/RAT list, and the HPLMN UDM 109 forwards the SoR info to the UE 102. This embodiment also uses the signals (modified) shown in FIG. 6. The Nsoraf_SoR_Get response message 676 from the SoR-AF 113 may include SoR info with StayIndication information. Then the Nudm_SDM_Get response message 671 from the HPLMN UDM 109 may include SoR info with StayIndication information, and the Registration Accept message 682 from the VPLMN AMF 107 may include SoR info with StayIndication information which is received by the UE 102.

In an embodiment, based on a UE's location, the UE initiates negotiation of PSM/MICO/eDRX parameters and the like for power saving.

For example, a UE 102 triggers a NAS message, e.g., a Registration Request for Mobility Update 660, when the UE is about to be out of NTN coverage (before entering idle state due to the move out of NTN coverage), where the NAS message may optionally include different information. In an embodiment, the UE requests PSM/MICO/eDRX as described above based on the estimated of out-of-NTN coverage period and the estimated in-NTN coverage period, with no change in NAS message(s). In another embodiment, the NAS message, e.g., a Registration Request for Mobility Update, includes two new IEs: (1) an estimated out-of-NTN coverage period; and (2) an estimated in-NTN coverage period.

In an embodiment, the AMF 115 assigns the requested timers/parameters for PSM/MICO/eDRX in a Registration Accept message 682 to the UE based on the UE's requested timers/parameters of PSM/MICO/eDRX or the estimated out-of-NTN coverage period and the estimated in-NTN coverage period.

In some embodiments, after the UE registers to a VPLMN/satellite RAT, the Stay Indication information is configured via a PLMN/RAT list in SoR information to the UE (e.g., a procedure for providing list of preferred PLMN/access technology combinations is described in 3GPP technical documents).

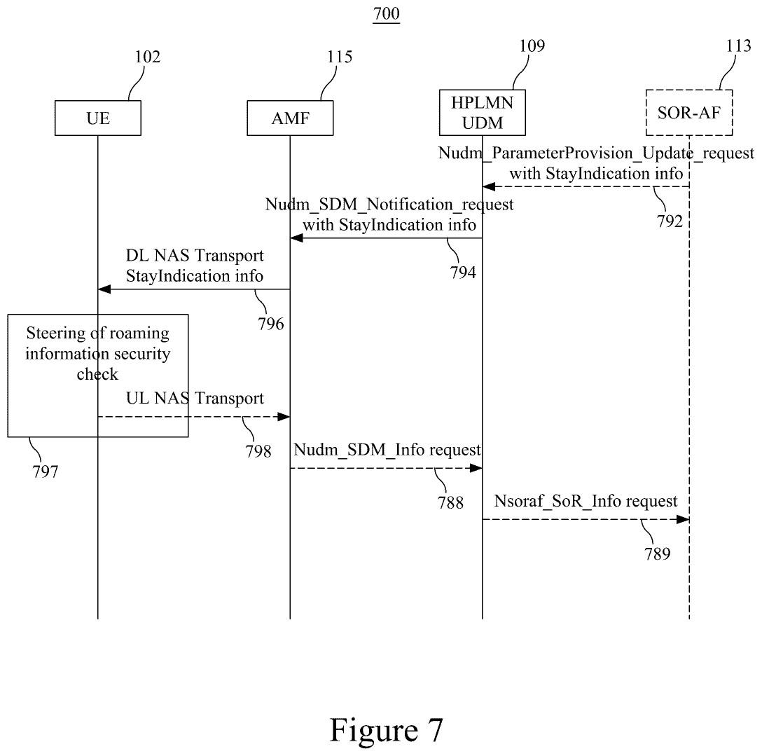

FIG. 7 is a signal diagram corresponding to a preparation stage configuring a UE to refrain from seeking other radio communication during discontinuous NTN coverage after initial UE registration with a VPLMN, according to an embodiment. This signal diagram is similar with the one illustrated in 3GPP TS 23.122 Figure C.3.1 modified so that the StayIndication is included in the step 1 therein (Nudm_ParameterProvision_Update request), passed down in step 2 (Nudm_SDM_Notification request) and further passed down in step 3 within the DL NAS TRANSPORT message.

FIG. 7 shows a procedure 700 for providing a list of preferred PLMNs/access technology combinations which may also be used for providing StayIndication information to a UE 102. Initially, the SoR-AF 113 transmits a Nudm_ParameterProvision_Update_request message 792 to the HPLMN UDM 109, which in turn transmits an Nudm_SDM Notification request message 794 to the AMF 115. The AMF 115 transmits a DL NAS Transport message 796 to the UE 102. The UE 102 performs a Steering of Roaming information security check as event 797. Upon completion of the information security check, the UE 102 transmits a UL NAS Transport message 798 to the AMF 115 which in turn transmits an Nudm_SDM_Info request message 788 to the HPLMN UDM 109. The HPLMN UDM 109 transmits an Nsoraf_SoR_Info request message 789 to the SoR-AF 113.

In one embodiment, the signals illustrated in FIG. 7 may be modified as now described. When receiving SoR info from the SoR-AF, 113 the HPLMN UDM 109 includes StayIndication information per PLMN with Satellite RAT in the combined PLMN/RAT list. The Nudm SDM_Notification request message 794 includes SoR info with Stay Indication information. The AMF 115 transmits the DL NAS Transport message 796 which includes SoR info with StayIndication information to the UE 102.

In another embodiment, the SoR-AF 113 includes StayIndication per PLMN with Satellite RAT in the combined PLMN/RAT list to the HPLMN UDM 109, and the HPLMN UDM 109 forwards the SoR info to the UE 102. This occurs by the SoR 113 transmitting the Nudm_ParameterProvision_Update request message 792 which includes SoR info with StayIndication information to the HPLMN UDM 109. Next, the HPLMN UDM 109 transmits the Nudm_SDM_Notification message 794 which includes the SoR info with Stay Indication information to the AMF 115. Then, the AMF 115 transmits the DL NAS Transport message 796 which includes SoR info with StayIndication information to the UE 102.

The HPLMN UDM may configure the UEs with the StayIndication on a per-PLMN basis for UEs accessing a satellite RAT. For example, the PLMN may be a Home PLMN, an equivalent HPLMN, equivalent PLMNs, or a Visiting PLMN.

Further granularities may be provided to different Satellite RATs of a PLMN. For example, the configuration of Stay Indication may be on a per-PLMN or a per-satellite RAT basis for the UE.

Some embodiments include mechanisms of negotiation of PSM/MICO/eDRX for power saving between the UE and the current PLMN/satellite RAT when the UE is out-of-NTN coverage and stays with the current PLMN/satellite RAT.

When the UE may determine that it needs to stay at the current PLMN/satellite RAT, based on available information (e.g., UE location, NTN coverage information, or network assisted information), the UE initiates negotiating the power saving mechanism for use when out-of-NTN coverage and staying at the serving PLMN/Satellite RAT as described below.

In an embodiment, based on the features and functionalities associated with 3GPP technical documents, power saving enhancement takes into account the estimate of the out-of-NTN coverage period or the estimate of the in-NTN coverage period. For mobile reachability of mobile reachable timer, the UE may request the Periodic TAU Timer value in the Registration Request Message, whereby the Periodic TAU Timer value is set based on the estimate of the out-of-NTN coverage period.

For Power Saving Mode (PSM) the UE may request an Active Time value based on the estimate of in-NTN coverage period and a Periodic TAU Timer value based on the estimate of out-of-NTN coverage period in the Registration Request Message. The AMF takes the UE requested values into account to assign an Active Time value and Periodic TAU Timer value in the Registration Accept message. If the AMF is aware of NTN coverage and has the estimated out-of-NTN coverage period and estimated in-NTN coverage period, the AMF considers both UE requested values and NTN coverage to assign Active Time value and Periodic TAU Timer value.

For MICO mode with (optional) Active Time, the UE may request an Active Time value based on the estimate of in-NTN coverage period during the Registration procedure. The AMF takes the UE requested values into account and assigns the Active Time value in the Registration Accept message. If the AMF is aware of NTN coverage and has the estimated in-NTN coverage period, the AMF considers both UE requested values and NTN coverage to assign Active Time value for MICO mode.

For eDRX, the UE requests eDRX parameters (e.g., cycle length) based on the estimate of the out-of-NTN coverage period and the estimate of the in-NTN coverage period during the Registration Request procedure. The AMF takes the UE requested values into account and assigns the eDRX parameters in the Registration Accept message. If the AMF is aware of NTN coverage and has the estimated in-NTN coverage period and estimated out-of-NTN coverage period, the AMF considers both UE requested values and NTN coverage to assign eDRX parameters.

High Latency Communication, HLCOM, may be applied while the UE is in PSM/MICO mode to buffer data in the network within the estimated out-of-NTN coverage period, or notify the AF about UE reachability with information about the estimated out-of-NTN coverage period, as applicable. Tracking Area or RAT based AMF configuration of an implicit deregistration timer may be adjusted based on the estimated out-of-NTN coverage period to ensure that the UE is not implicitly deregistered by the network when the UE is out of NTN coverage and the Periodic TAU Timer expires.

Embodiments may include procedures to trigger negotiation of the PSM/MICO/eDRX for power saving based on UE awareness of NTN coverage and UE location.

For UE awareness of NTN coverage, the UE may get NTN coverage information based on SIB19, or NTN coverage information from 5G CN/NWDAF or AF. For UE location, it is assumed that the UE has the capability to determine its location (e.g., by GNSS or by positioning procedures at the UE as indicated in 3GPP technical documents). If the UE is with satellite RAT only or in conjunction with embodiment with the StayIndication configured at UE, and if the UE has awareness of NTN coverage and UE location, there are options for initiating negotiation of PSM/MICO/eDRX for power saving, which are described below.

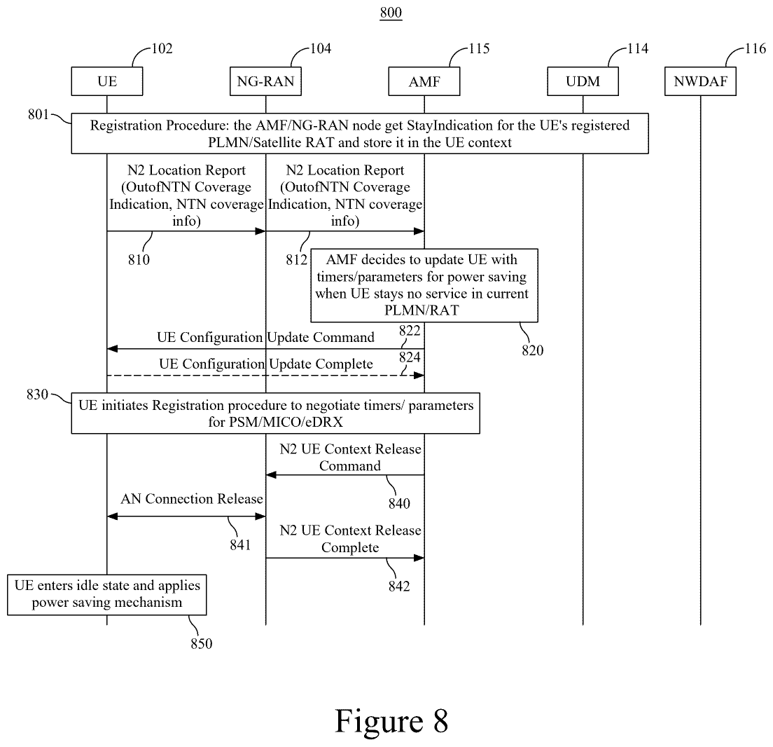

In an embodiment, based on a UE's location report, the AMF initiates negotiation of timers/parameters of PSM/MICO/eDRX for power saving. Prior to describing this embodiment in detail, a signaling diagram 800 which supports this embodiment is now described with respect to FIG. 8. FIGS. 8-10 are embodiments related to an “execution” stage (UE triggered, AMF initiated, or NG-RAN initiated) in contrast to FIGS. 4-7 that are related to a “preparation” stage 801, 901, 1001 during which the UE acquires the StayIndication info. Thus, FIG. 8 is a signal diagram corresponding to an execution stage where the UE triggers a UE power saving configuration during discontinuous NTN coverage, according to an embodiment.

In FIG. 8, there is a Registration Procedure 801 in which the AMF 115 and the NG-RAN node 104 get StayIndication information for the UE's registered PLMN/satellite RAT and store it in the UE context. The UE 102 transmits 810 N2 location report (OutofNTN Coverage Indication, NTN coverage information) to the NG-RAN node 104 which transmits 812 the same information to the AMF 115. The AMF decides 802 to update the UE with timers/parameters for power saving when the UE stays without service in its current PLMN/RAT. The AMF 115 transmits a UE Configuration Update Command 822. The UE 102 responds 824 with a UE Configuration Update Complete message 824. The UE initiates 830 a Registration Procedure to negotiate timers/parameters for PSM/MICO/eDRX with the network. The AMF 115 transmits an N2 Context Release Command message 840 to the NG-RAN. The AMF 115 and the UE 102 communicate and perform 841 an Access Node, AN, connection release. The NG-RAN node 104 transmits an N2 UE Context Release Complete message 842 to the AMF 115. The UE enters an idle state and applies power saving mechanism(s) as shown in event 850.

In an embodiment, in the registration procedure 801, the AMF 115 gets the StayIndication information from the UDM 114 as described above in another embodiment. The AMF 115 stores the StayIndication information for the current PLMN/satellite RAT in the UE context and provides the information to the NG-RAN node 104 in the Initial UE context setup message. This is needed for a handover procedure if it involves the change of the serving AMF. The NG-RAN node 104 stores the StayIndication information for the current PLMN/satellite RAT in the UE context. This is needed for the handover procedure if it involves the change of the serving NG-RAN node.

In an embodiment, based on the stored StayIndication for the current PLMN/satellite RAT, the UE 102 sends one of the following message(s) and information to the NG-RAN node 104 based on the following options: (1) a Location Report (including UE location, and OutofNTNCoverage indication); (2) a Location Report (UE location) and a new RRC message (including OutofNTNCoverage indication); (3) a Location Report (including OutofNTNCoverage indication and NTN coverage information); (4) a new RRC message (including OutofNTNCoverage indication and NTN coverage information).

For option (1) and (2) above, the NG-RAN node 104 calculates the NTN coverage information based on UE location and ephemeris data to calculate an estimate of the out-of-NTN coverage period and an estimate of the in-NTN coverage period.

For options (3) and (4) above, the UE based on its location and NTN coverage information (based on ephemeris data) calculates an estimate of the out-of-NTN coverage period and an estimate of the in-NTN coverage period.

The NG-RAN node 104 then forwards the information representing the OutofNTNCoverage indication and the NTN coverage information via N2 Location Report or a new NGAP UE-associated message to the AMF 115, where the NTN coverage information may be ephemeris data based on UE location, the estimated in-NTN Coverage period and estimated out-of-NTN coverage period.

With the OutofNTNCoverage indication, the AMF 115 proceeds using the active Stay Indication for the current PLMN/satellite RAT and NTN coverage information, the AMF 115 determines 820 whether to update the UE with timers/parameters for power saving for the UE staying out of NTN coverage.

In an embodiment, the AMF 115 sends a UE Configuration Update command 822 containing UE parameters related to power saving mechanism for the UE staying out of NTN coverage. Parameters may include PLMN-assigned StayIndication, recommended power saving mechanism (e.g., MICO, PSM, and eDRX). If the AMF 115 indicates PLMN-assigned StayIndication, then the UE 102 shall update the configuration for the current PLMN/Satellite RAT based on received information. The AMF 115 includes recommended power saving mechanism, e.g., MICO, PSM, and eDRX, based on the UE capability, UE subscriptions, network capability, operator's local policy, and the like.

The UE Configuration Update Command message 822 may also include the following: (1) an indication requesting to perform re-registration; (2) an optional indication to notify completion of UE Configuration Update 824 from UE 102, otherwise the procedure determines the power saving mechanism; and (3) estimate of in-NTN coverage period, and estimate of out-of-NTN coverage period if StayIndication is active for the current PLMN/RAT.

In an embodiment, the UE initiates Registration procedure 830 to determine the power saving mechanism, e.g., MICO, PSM, and eDRX, based on its capability for the estimate of in-NTN coverage period and estimate of out-of-NTN coverage period, and then sends registration procedure with registration type indicated as Mobility Update and with requested timers/parameters set based on the estimated in-NTN coverage period and estimated out-of-NTN coverage period. The AMF 115 returns a Registration Accept message including timers/parameters of power saving, including Active time, Periodic TAU time, eDRX, etc.

In an embodiment, there are procedures to trigger negotiation of the PSM/MICO/eDRX for power saving based on AMF awareness of NTN coverage and UE location.

In an embodiment, for AMF 115 awareness of NTN coverage, it is assumed that the AMF may get rigorous NTN coverage information from the NG-RAN or other network functions, NFs, in a 5G CN.

For the case of an NG-RAN node 104, the AMF 115 may request NG-RAN for providing NTN coverage information by two methods. In a first method, the AMF 115 may request NG-RAN for providing NTN coverage information via a new non-UE associated next generation application protocol, NG-AP, message including Area of Interest, AOI, information, e.g., by referring to predefined areas that are represented by a list of Tracking Areas, list of cells or list of (R) AN node identifiers. In a second method, the AMF 115 may request NG-RAN for providing NTN coverage information via a new UE-associated NG-AP message based on UE ID, and AOI information.

In an embodiment, for AMF 115 awareness of UE 102 location, the AMF 115 may get the UE 102 location information from other NFs in 5G CN or from NG-RAN node 104. For the latter case of an NG-RAN node 104, the AMF 115 may request the NG-RAN node 104 via the Location Reporting Control procedure in 3GPP TS38.413 the UE's current location, or the UE's last known location with a time stamp, or the UE's presence in the area of interest while in CM-CONNECTED state as specified in 3GPP TS 23.501 and 3GPP TS 23.502. The procedure uses UE-associated signaling. In this case, it is assumed that the UE has the capability to determine its location (e.g., by GNSS or by positioning procedures at the UE as indicated in 3GPP TS 23.273) and report its location to NG-RAN via RRC message(s).

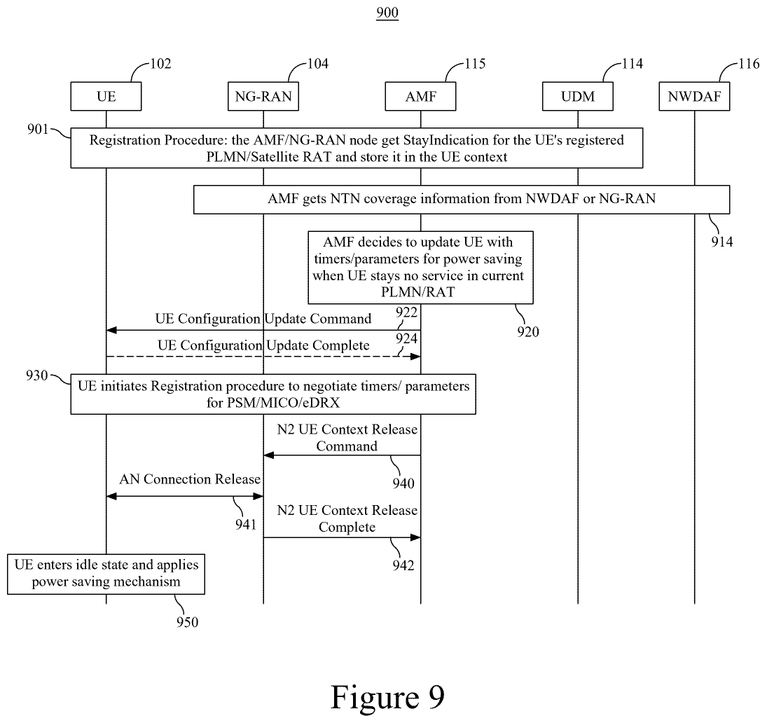

If the UE 102 is with Satellite RAT only or following embodiments associated with StayIndication configured at the UE 102, for the case of AMF awareness of NTN coverage/UE location, the AMF 115 initiates a UE configuration Update procedure to provision the UE 102 with recommended idle mode timers when the UE 102 is about to be out of NTN coverage (before entering idle state due to the move out of NTN coverage). FIG. 9 is a signal diagram corresponding to an execution stage where the AMF triggers a UE power saving configuration during discontinuous NTN coverage, according to an embodiment.

Initially, there is a Registration Procedure 901 in which the AMF 115 and the NG-RAN node 104 get StayIndication information for the UE's registered PLMN/satellite RAT and store it in the UE context. The AMF 115 gets NTN coverage information 914 from other NFs in 5G CN, e.g. a network data analytics function, NWDAF, or NG-RAN. The NTN coverage information may be ephemeris data based on AOI information requested by the AMF 115, e.g. by referring to predefined areas that are represented by a list of Tracking Areas, list of cells or list of (R) AN node identifiers, and the estimate of in NTN coverage period and estimated out-of-NTN coverage period. The AMF decides 920 to update the UE with timers/parameters for power saving when the UE stays without service in its current PLMN/RAT. The AMF 115 transmits a UE Configuration Update Command 922. The UE 102 responds with a UE Configuration Update Complete message 924. The UE initiates 930 a Registration Procedure to negotiate timers/parameters for PSM/MICO/eDRX with the network. The AMF 115 transmits an N2 Context Release Command message 940 to the NG-RAN. The AMF 115 and the UE 102 communicate and perform 941 an AN connection release. The NG-RAN node 104 transmits an N2 UE Context Release Complete message 942 to the AMF 115. The UE enters an idle state and applies power saving mechanism(s) as shown in event 950.

In an embodiment, there is case of NG-RAN awareness of NTN coverage and UE location, which provides a procedure to trigger negotiation of the PSM/MICO/eDRX for power saving.

For NG-RAN awareness of NTN coverage, it is assumed that the NG-RAN node may get rigorous NTN coverage information, e.g., including cells in other NG-RAN nodes, from operation and maintenance, O&M, or NWDAF via the AMF.

For NG-RAN awareness of UE location, the NG-RAN may get the UE location information from NFs in 5G CN, e.g., AMF/NWDAF, or from the UE 102 directly or indirectly.

For the latter case, it is assumed that the UE has the capability to determine its location (e.g., by GNSS or by positioning procedures at the UE as indicated in, e.g., 3GPP TS 23.273), with user consent, and report its location.

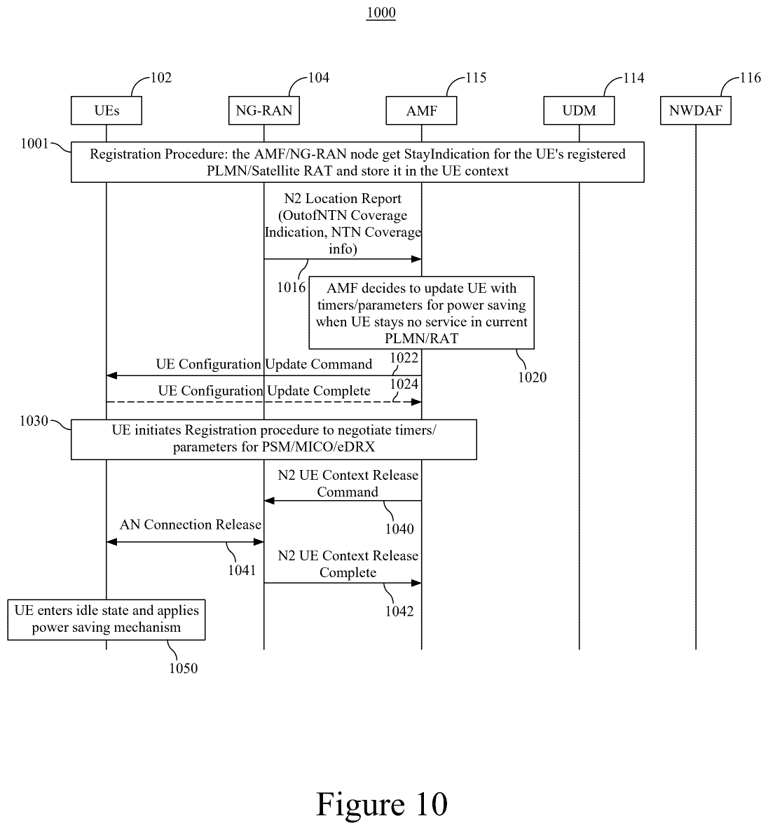

If the UE is with Satellite RAT only or following embodiments based on a Stay Indication configured at UE, for the case of NG-RAN awareness of NTN coverage/UE location, the NG-RAN initiates the UE to negotiate PSM/MICO/eDRX for power saving in idle mode as is described with respect to the signaling diagram 1000 shown in FIG. 10. FIG. 10 is a signal diagram corresponding to an execution stage where the NG-RAN triggers a UE power saving configuration during discontinuous NTN coverage second scenario, according to an embodiment.

Initially, there is a Registration Procedure 1001 in which the AMF 115 and the NG-RAN node 104 get StayIndication information for the UE's registered PLMN/satellite RAT and store it in the UE context. Based on the stored StayIndication for the current PLMN/Satellite RAT and UE location (coarse or rigorous) information, the NG-RAN node 104 determines that the UE 102 may be moving out of coverage soon and sends the information 1016 of OutofNTNCoverage indication and NTN coverage information via N2 Location Report or a new NGAP UE-associated message to the AMF. The NTN coverage information may be ephemeris data based on AOI information requested by the AMF 115 (e.g., by referring to predefined areas that are represented by a list of Tracking Areas, list of cells or list of (R) AN node identifiers), the estimate of in NTN coverage period and estimate of out of NTN coverage period.

Using the OutofNTNCoverage indication, the AMF decides 1020 to update the UE with timers/parameters for power saving when the UE stays without service in its current PLMN/RAT. The AMF 115 transmits a UE Configuration Update Command 1022. The UE 102 responds with a UE Configuration Update Complete message 1024. The UE initiates 1030 a Registration Procedure to negotiate timers/parameters for PSM/MICO/eDRX with the network. The AMF 115 transmits an N2 Context Release Command message 1040 to the NG-RAN. The AMF 115 and the UE 102 communicate and perform 1041 an AN connection release. The NG-RAN node 104 transmits an N2 UE Context Release Complete message 942 to the AMF 115. The UE enters an idle state and applies power saving mechanism(s) as shown in event 1050.

The mechanisms disclosed herein are also applicable to EPS, e.g., may be analogous to using Attach or TAU.

Embodiments described herein, have been associated with a UE being in discontinuous NTN coverage. However, in an embodiment, a UE may also perform a process when the UE accesses a Satellite Radio Access Technology, RAT, in a serving Public Land Mobile Network, PLMN.

This embodiment describes using a satellite RAT as an example for a UE accessing a PLMN/Satellite RAT. The aspect is applied to a UE with a single-RAT-only capability or a UE configured with information for staying at current PLMN/RAT by the network operators based on network operator policies, UE subscriptions, etc.

The UE determines whether to stay at a current PLMN/Satellite RAT once the UE moves out a non-terrestrial network, NTN, coverage, based on the following conditions: (1) if the UE is configured by the network with information for staying at current PLMN/Satellite RAT in an out-of-NTN coverage; (2) if the UE's capability is with Satellite RAT only; and/or (3) if the current PLMN/Satellite RAT is the only available access before moving out of NTN coverage (this is an optional UE implementation because the UE may still have a chance to access an available PLMN/RAT in idle mode)

If the UE determines that it needs to stay at the current PLMN/Satellite RAT based on the available information in the UE (e.g., UE location, NTN coverage information, or network assisted information), the UE determines to negotiate the power saving mechanism for use when moving out of NTN coverage and staying at the serving PLMN/Satellite RAT.

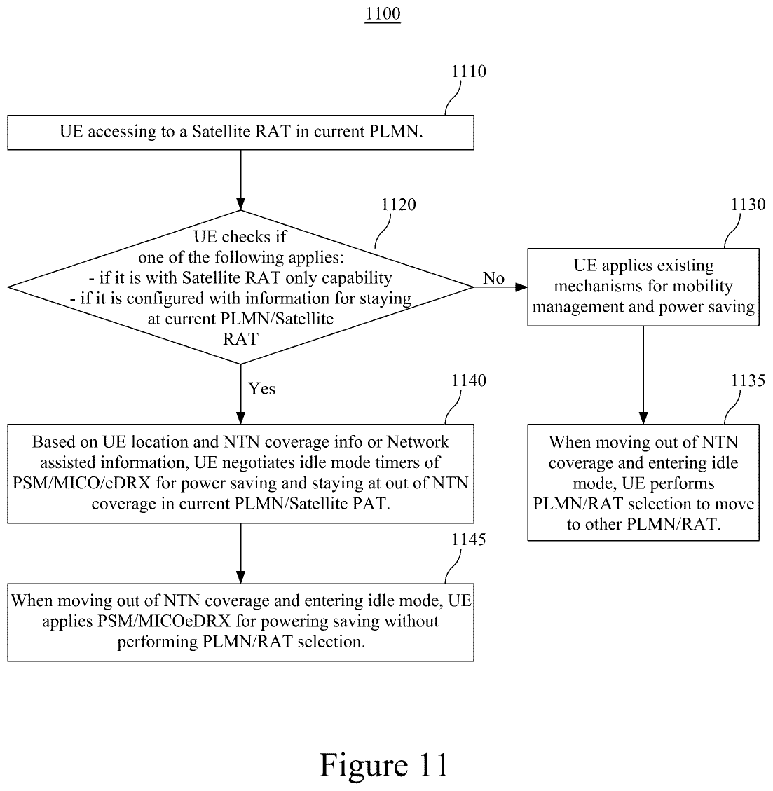

In an embodiment, the UE procedure for accessing a satellite RAT in a serving PLMN is now described with respect to the flowchart 1100 shown in FIG. 11. Thus, FIG. 11 is a flowchart of a UE method, according to an embodiment.

Initially, event 1110 reflects the UE accessing a satellite RAT in its current PLMN. Then, the UE decides to check 1120 to determine if one of the following conditions applies: (1), if the UE is with a satellite RAT only capability; or (2) if the UE is configured with information (e.g., StayIndication) for remaining in its current PLMN (via satellite RAT). If the determination is a No, i.e., that neither condition applies to the UE, then the UE applies 1130 existing mechanisms for mobility management and power saving(s) and when the event 31135 of moving out of NTN coverage and entering idle mode occurs, the UE performs PLMN/RAT selection to move to another PLMN/RAT.

If the determination is a Yes, then based on UE location and NTN coverage information or network assisted information, the UE determines 1140 to negotiate idle mode timers, with its network, of (at least one) PSM/MICO/eDRX for power saving and stating out of NTN coverage in its current PLMN/satellite RAT. Then, when moving out of NTN coverage and entering idle mode 1145 the UE applies PSM/MICO/eDRX idle mode timers (and other associated power saving features as desired) without performing a new PLMS/RAT selection.

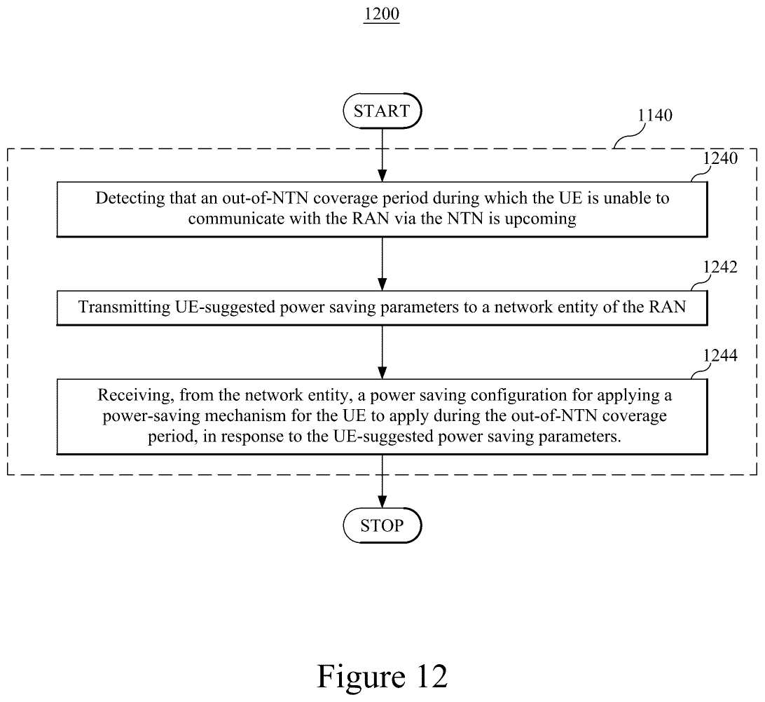

FIG. 12 is a flowchart of a wireless communication method 1200 performed by a user equipment, UE, connected to a radio access network, RAN, via a non-terrestrial network, NTN, according to an embodiment. The method 1200 includes: detecting 1215 that an out-of-NTN coverage period during which the UE is unable to communicate with the RAN via the NTN is upcoming; transmitting 1242 a UE-suggested power saving parameters to a network entity of the RAN; and receiving 1244, from the network entity, a power saving configuration for applying a power-saving mechanism during the imminent out-of-NTN coverage period, in response to the UE-suggested power saving parameters.

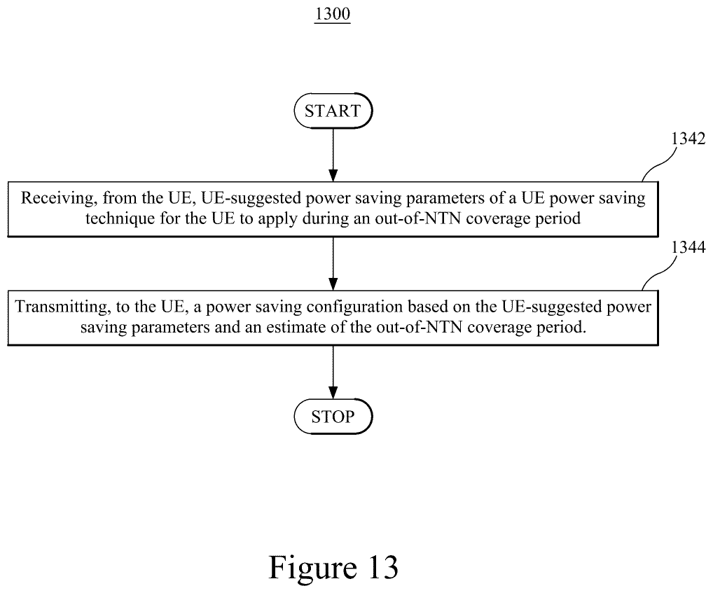

FIG. 13 is a flow chart of a wireless communication method 1300 performed by a radio access network, RAN, connected to a user equipment, UE, via a non-terrestrial network, NTN, according to an embodiment. The method 1300 includes: receiving 1342 from the UE, UE-suggested power saving parameters of a UE power saving technique for the UE to apply during an out-of-NTN coverage period; and transmitting 1344, to the UE, a power saving configuration based on the UE-suggested power saving parameters and an estimate of the out-of-NTN coverage period.

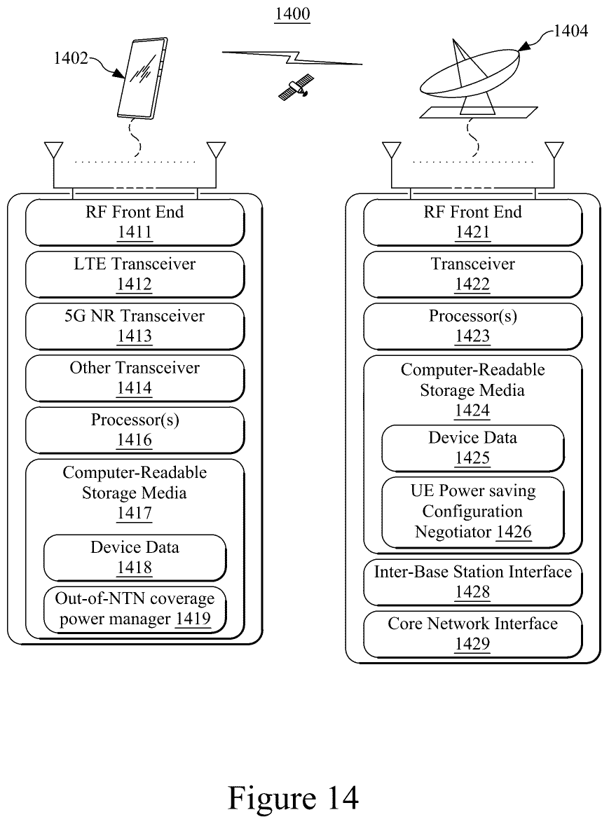

FIG. 14 illustrates a wireless communication system 1400 including a UE and a NE configured to embodiments as described above. Methods and devices described in this section embody techniques related to, for example, wireless communication in an NTN, signals and decisions associated with power saving management, signals and decisions associated with mobility management and the like. NE 1404 and UE 1402 communicate wirelessly and are configured to support power saving management traffic and related information. NE 1404 and UE 1402 may include additional functions and interfaces omitted from FIG. 14 in the interest of brevity. Arrow generally represents both uplink signals (from the UE to the NE) and downlink signals (from the NE to the UE) which may be relayed via a satellite.

NE 1404 as illustrated in FIG. 14 may provide the functionality of an gNB (i.e., a 5G or 6G base station). NE 1404's functionality may be distributed across multiple entities (e.g., a central unit, CU, a distributed unit, DU, and a radio unit, RU). NE 1404 includes antennas, a Radio Frequency, RF, front end 1421 and a transceiver 1422 for communicating with UE 1402 and other UEs and NEs. NE 1404's antennas and RF front end 1421 may be tuned to one or more frequency bands (e.g., subcarriers), for example as defined by 3GPP LTE, 5G NR, and 6G communication standards and implemented by transceiver 1422.

NE 1404 further includes processor(s) 1423 and computer-readable storage media, CRM, 1424. Processor(s) 1423 may include single or multiple-core processors, and CRM 1424 includes any suitable memory/storage except propagating signals. For example, memory/storage may include random-access memory, RAM, static RAM, SRAM\, dynamic RAM, DRAM, non-volatile RAM, NVRAM, read-only memory, ROM, and/or flash memory. CRM 1424 stores device data 1425, which includes network scheduling data, radio resource management data, applications, and/or an operating system, which are executable by processor(s) 1423 to enable wireless communication with UE 1402 as well as with other NEs and UEs.

CRM 1424 also stores device data 1425 and a UE power saving configuration negotiator 1426. Device data 1425 stores information as needed related to the NE and its operations and communications. The UE power saving configuration negotiator 1426 includes instructions, parameter information and the like which is used in support of embodiments described herein associated with power saving management and negotiation, i.e., when and what the network provides to the UE in support of negotiating power saving management parameters before the UE is in an out of coverage situation associated with an NTN.

NE 1404 also includes inter-base station interface 1428 and core-network interface 1429. Inter-base station interface 1428 may be a standardized interface, such as an Xn and/or X2 interface, for exchanging user-plane and control-plane data with another NE (e.g., in case of a handover). Core-network interface 1429 enables NE's user-plane data and control-plane information exchange with core network functions and/or entities.

UE 1402 includes antennas connected to a RF front end 1411, and a transceiver 1412. Transceiver 1412 may be an LTE transceiver 1412, a 5G NR transceiver 1413, or another transceiver 1414. The UE may include multiple transceivers. The antennas and RF front end 1411 may be tuned to one or more frequency bands (e.g., subcarriers), for example, as defined by 3GPP LTE, 5G NR, and 6G communication standards and implemented by respective transceivers. UE 1402 also includes one or more processor(s) 1416, and CRM 1417. Processor(s) 1416 may be single or multiple-core processors, and CRM 1417 includes any suitable memory/storage other than propagating signals. For example, memory/storage may include RAM, static RAM, dynamic RAM, non-volatile RAM, ROM, and/or flash memory. CRM 1417 stores device data 1418 necessary for UE's communications, and information/instructions in support of the out-of-NTN coverage power manager 1419. The out-of-NTN coverage power manager 1419 includes information and used in support of power savings negotiation with a network for determining power saving settings for use when out of coverage in an NTN as described in embodiments herein.

A user device, e.g., a UE, in which the techniques described in this section may be implemented may be any suitable device capable of wireless communications such as a smartphone, a tablet computer, a laptop computer, a mobile gaming console, a point-of-sale, POS, terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system, ADAS. Still further, the user device may operate as an internet-of-things, IoT, device or a mobile-internet device, MID. Depending on the type, the user device may include one or more general-purpose processors, a computer-readable memory, a user interface, one or more network interfaces, one or more sensors, etc.

Certain embodiments are described in this disclosure as including logic or a number of components or modules. Modules may be software modules (e.g., code stored on non-transitory machine-readable medium) or hardware modules. A hardware module is a tangible unit capable of performing certain operations and may be configured or arranged in a certain manner. A hardware module may comprise dedicated circuitry or logic that is permanently configured (e.g., as a special-purpose processor, such as a field programmable gate array, FPGA, or an application-specific integrated circuit, ASIC) to perform certain operations. A hardware module may also comprise programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques may be provided as part of the operating system, a library used by multiple applications, a particular software application, etc. The software may be executed by one or more general-purpose processors or one or more special-purpose processors.

1-18. (canceled)

19. A wireless communication method performed by a first wireless device, connected to a second wireless device via a non-terrestrial network, NTN, the method comprising:
detecting that an out-of-NTN coverage period is upcoming based on NTN-coverage information,
UE location information of a user equipment, UE, that is either the first wireless device or the second wireless device, and
an indication as to whether the UE is to remain at a currently serving NTN; and
negotiating, with the second wireless device before the out-of-NTN coverage period begins, a power saving configuration for a power saving mechanism to be used during the out-of-NTN coverage period,
wherein the UE is configured to refrain from seeking other radio communication access during an out-of-NTN coverage period.

20. The wireless communication method of claim 19, wherein the
detecting further comprises:
receiving, from the second wireless device or a dedicated network entity, the NTN-coverage information, the UE location information, or the indication as to whether the UE is to remain at the currently serving NTN.

21. The wireless communication method of claim 19, wherein a network-related-information-repository entity provides the indication directly or indirectly during a registration procedure, a get procedure, or a subscribe procedure as defined in 3GPP specifications.

22. The wireless communication method of claim 19, wherein the first wireless device is the UE, the second wireless device is a network entity, NE, and the negotiating comprises:
transmitting UE-suggested power saving parameters;
in response to the transmitting of the UE-suggested power saving parameters, receiving the power saving configuration that is based on the UE-suggested power saving parameters; and
applying the power saving mechanism according to the power saving configuration.

23. The wireless communication method of claim 22, wherein
the power saving mechanism is a Power Saving Mode, PSM, as defined in 3GPP technical specifications,
the UE-suggested power saving parameters include a suggested Active Time value for applying the PSM, and
the power saving configuration includes a configured Active Time value for applying the PSM.

24. The wireless communication method of claim 22, wherein
the power saving mechanism is a Mobile Initiated Connection Only, MICO, as defined in 3GPP technical specifications,
the UE-suggested power saving parameters include a suggested Active Time value for applying the MICO, and
the power saving configuration includes a configured Active Time value for applying the MICO.

25. The wireless communication method of claim 22, wherein
the power saving mechanism is an extended Discontinuous Reception, eDRX, as defined in 3GPP technical specifications,
the UE-suggested power saving parameters include at least a suggested idle-mode cycle length for the eDRX, and
the power saving configuration includes a configured idle-mode cycle length value for applying the eDRX.

26. The wireless communication method of claim 19, wherein the first wireless device is a network entity, NE, the second wireless device is the UE, and the negotiating comprises:
receiving UE-suggested power saving parameters; and
transmitting the power saving configuration based on the UE-suggested power saving parameters.

27. The wireless communication method of claim 26, wherein the NE is a base station.

28. The wireless communication method of claim 26, wherein the NE is a core network device executing an Access and Mobility Management Function, AMF, as defined in 3GPP technical specifications.

29. The wireless communication method of claim 19, further comprising:
configuring, during a registration procedure, the UE to refrain from seeking radio communication access from a network other than the currently serving NTN.

30. The wireless communication method of claim 19, further comprising:
configuring the UE to refrain from seeking radio communication access from a network other than the currently serving NTN using a UE parameter update procedure.

31. The wireless communication method of claim 19, further comprising:
configuring the UE to refrain from seeking radio communication access from a network other than the currently serving NTN using Steering of Roaming, SoR, information.

32. The wireless communication method of any of claim 19, wherein the indication specifies a network operator identifier and a radio access technology type of the NTN.

33. The wireless communication method of claim 32, wherein the network operator identifier indicates a public land mobile network, PLMN.

34. The wireless communication method of claim 19, further comprising:
releasing a connection between the first wireless device and the second wireless device before the out-of-NTN coverage period begins.

35. A user equipment, UE, comprising:
a transceiver configured to facilitate communication with a network equipment, NE, via a non-terrestrial network, NTN; and
a processor connected to the transceiver and configured
to detect that an out-of-NTN coverage period is upcoming based on NTN-coverage information, UE location information of the UE, and an indication as to whether the UE is to remain at a currently serving NTN, and
to negotiate with the NE before the out-of-NTN coverage period begins, a power saving configuration for a power saving mechanism to be used during the out-of-NTN coverage period,
wherein the UE is configured to refrain from seeking other radio communication access during an out-of-NTN coverage period.

36. The UE of claim 35, wherein the processor negotiates the power saving configuration by:
transmitting UE-suggested power saving parameters, and in response to the transmitting of the UE-suggested power saving parameters,
receiving the power saving configuration that is based on the UE-suggested power saving parameters,
the processor then applying the power saving mechanism according to the power saving configuration.

37. A network entity, NE, comprising:
a transceiver configured to facilitate communication with a user equipment, UE, via a non-terrestrial network, NTN; and
a processor connected to the transceiver and configured
to detect that an out-of-NTN coverage period is upcoming based on NTN-coverage information, UE location information of the UE, and an indication as to whether the UE is to remain at a currently serving NTN, and
to negotiate with the NE before the out-of-NTN coverage period begins, a power saving configuration for a power saving mechanism to be used during the out-of-NTN coverage period,
wherein the UE is configured to refrain from seeking other radio communication access during an out-of-NTN coverage period.

38. The NE of claim 37, wherein the processor negotiates the power saving configuration by
receiving UE-suggested power saving parameters, and transmitting the power saving configuration based on the UE-suggested power saving parameters.
